(19) United States
(12) Patent Application Publication
(10) Pub. No.: US 2025/0385335 A1
(43) Pub. Date: Dec. 18, 2025

(54) Dynamically Pressurized Pouch Battery System

(71) Applicant: Southwest Research Institute, San Antonio, TX (US)

(72) Inventor: Andre Swarts, Helotes, TX (US)

(21) Appl. No.: 18/744,667

(22) Filed: Jun. 16, 2024

(51) Int. Cl. H01M 10/647; H01M 10/613; H01M 10/63; H01M 10/6568; H01M 50/202; H01M 50/211

(52) U.S. Cl. CPC H01M 10/647; H01M 10/613; H01M 10/63; H01M 10/6568; H01M 50/202; H01M 50/211

(57) ABSTRACT

A dynamically pressurized pouch battery system. One or more pouch batteries are placed in a fixed volume enclosure, which also contains coolant in direct contact with the pouch battery(s). A pump pumps the coolant into and out of the enclosure, thereby varying the pressure exerted by the coolant upon the exterior of the pouch batteries. The pump may cause the coolant to provide more or less pressure depending on battery cell conditions, such as voltage, state-of-charge, age, state-of-health, or temperature.

### BACKGROUND OF THE INVENTION

Pouch cells are a type of lithium-ion battery that features a flexible pouch-shaped design. Pouch cells are constructed using a flexible enclosure that contains an anode, a cathode, electrolyte, and a separator. The electrodes are coated with conductive material, and the separator prevents direct contact between the electrodes. The flexible pouch is then sealed, forming a single, compact unit.

An advantage of pouch cells is their compact and lightweight design. Additionally, their flexibility can accommodate applications calling for irregular shapes and sizes. Pouch cells also have a higher energy density compared to other battery types, which means they can store more energy per unit of volume or weight. Pouch cells are used in a wide range of applications, including electric vehicles, consumer electronics, and energy storage systems.

A number of different approaches have been used or suggested for battery pouch cell cooling. These include passive cooling, surface cooling, heat transfer plates, edge cooling, and immersion cooling. For pouch cells, immersion cooling is complex because of the challenges in allowing a coolant fluid to contact the cell surfaces.

### BRIEF DESCRIPTION OF DRAWINGS

FIG. 1 illustrates a pouch battery containing a number of electrode layers.

FIG. 2 illustrates a dynamically cooled pouch battery system.

FIG. 3 illustrates an alternative embodiment of the dynamically cooled battery system, in which the enclosure is not completely filled with coolant.

### DETAILED DESCRIPTION OF THE INVENTION

The following description is directed to a battery pouch cell system that uses immersion cooling. A fixed volume enclosure contains one or more pouch cells as well as coolant. The pressure within the enclosure exerted upon the exterior of the pouch cells can be dynamically adjusted.

As stated in the Background, a trend in many battery applications is the use of pouch cells rather than cylindrical cells. Pouch cell batteries are typically tightly packed to provide support to counteract swelling and improve conductive heat transfer.

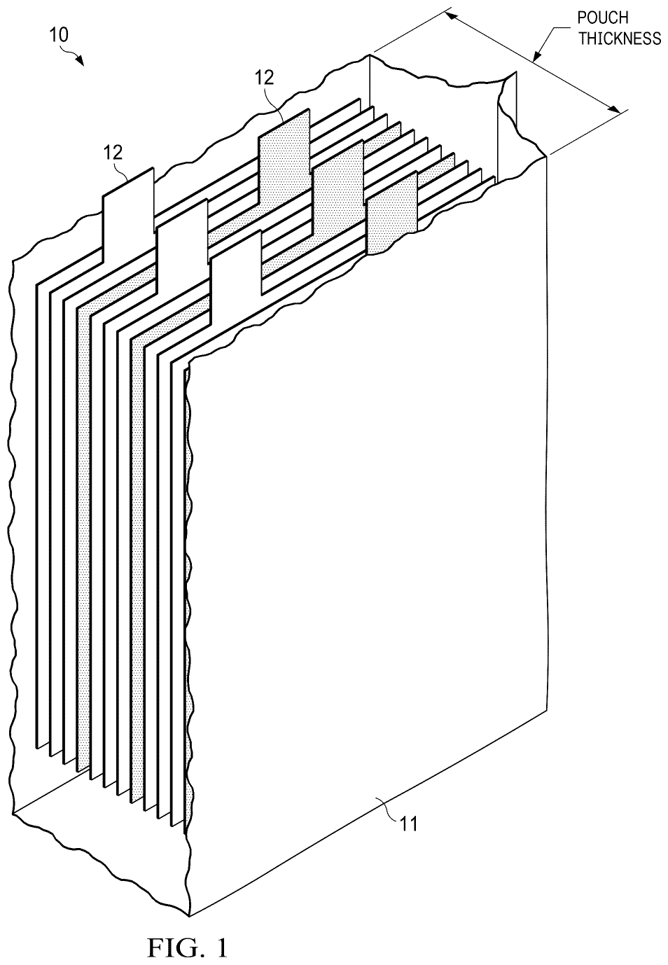

FIG. 1 illustrates a pouch battery 10 containing a number of electrode layers 12. The front end is open for purposes of illustration, but in practice the electrode layers are entirely enclosed within pouch 11.

Pouch 11 is flexible and provides pouch-like packaging without a rigid casing. Examples of suitable materials for pouch 11 are aluminum and polymer laminates.

Pouch batteries, such as battery 10, are known to swell (undergo a dimensional charge) during cycling (charging and discharging) and also as the pouch cell ages due to reactions within the cell, including the electrolyte. For purposes of this disclosure, changes are only considered in the thickness of the pouch (the smallest dimension) and not the length (the largest dimension where the electrode tabs typically are) nor the width (the intermediate dimension). This thickness dimension is indicated by the arrow in FIG. 1.

It is further known that the application of different constraining forces in the thickness dimension can cause different aging behavior. The force exerted by a constrained cell will increase over time as the cell ages.

In a pouch battery design, space is limited and for indirect cooling, battery cells are closely packed to enhance conductive heat transfer. Pouch batteries use either fixed force (by applying a pre-loading to the stack or cells) or a fixed displacement (that will effectively constrain the cell and apply a force once a certain displacement is reached). In the latter, the cells will have space to expand to a point, whereas in the former, the cells will immediately experience a force—in addition to the pre-load—that is proportional to the swelling. This requirement makes immersion cooling difficult since there is limited space for the coolant to contact the cells.

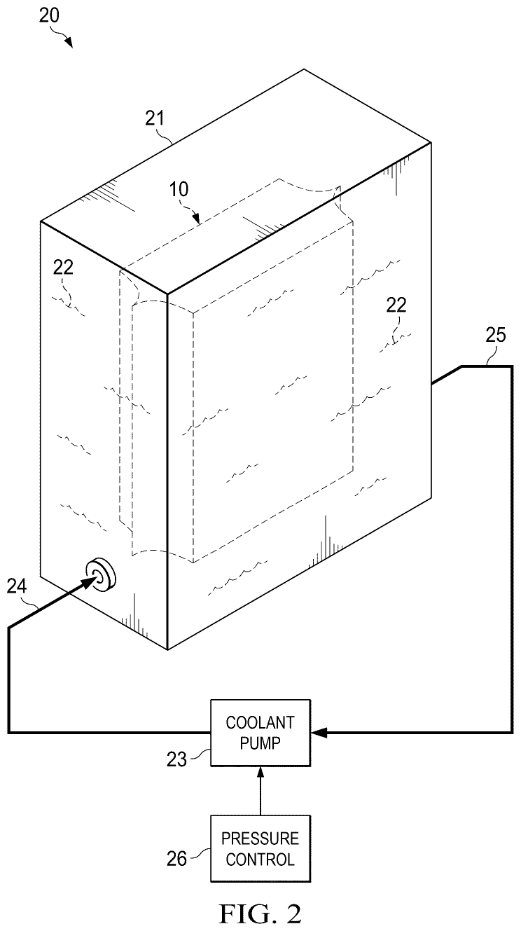

FIG. 2 illustrates a dynamically cooled pouch battery system 20 in accordance with one embodiment of the invention. System 20 has an enclosure 21 that contains a pouch battery, such as battery 10, which is immersed in a coolant 22.

In the example of FIG. 2, enclosure 21 contains only one pouch battery 10 but additional pouch batteries may be contained. Although not shown, a bracket or other support may be used to support pouch battery 10 within enclosure 21. If multiple pouch batteries are within enclosure 21, a frame may be used to both support them and to maintain spacing between multiple pouch batteries so that fluid can flow between them.

Enclosure 21 is a fixed volume enclosure. It is typically a rigid container, with an example of a suitable material being aluminum. Other than inlet(s) and outlet(s) as described below, enclosure 21 is sealed to contain the coolant 22. However, as explained below, the amount of coolant 22 within enclosure 21 may vary.

Coolant 22 is in direct contact with pouch battery 10, surrounding all or most of the exterior of its pouch 11. Coolant 22 can be of any type and may include single phase or phase change materials (PCMs). As explained below, in alternative embodiments, coolant 22 may fully flood enclosure 21 or there may be a headspace within enclosure 21 above a coolant liquid that contains a gas.

A pump 23 controls input and output of coolant 22 within enclosure 21 via inlet 24 and outlet 25. Pump 23 may be a variable speed pump, and the term “pump” is used herein to include various devices such as a positive displacement pump, accumulator, heat exchanger, filter and/or a pressure regulator. The significant feature of pump 23 is that it is suitable for pumping coolant 22 into enclosure 21 and thereby increasing the pressure exerted by coolant 22 upon the pouch battery 10.

A pressure controller 26 provides control of pump 23 to vary the pressure inside enclosure 21, that is, the pressure exerted by the coolant 22 upon the exterior of pouch 11.

In the embodiment of FIG. 2, enclosure 21 is completely filled with coolant 22. Pump 23 is used to apply pressure to coolant 22 and thereby dynamically vary pressure within enclosure 21. Pump 23 may be external to enclosure 21 as shown, or pump 23 may be located within enclosure 21.

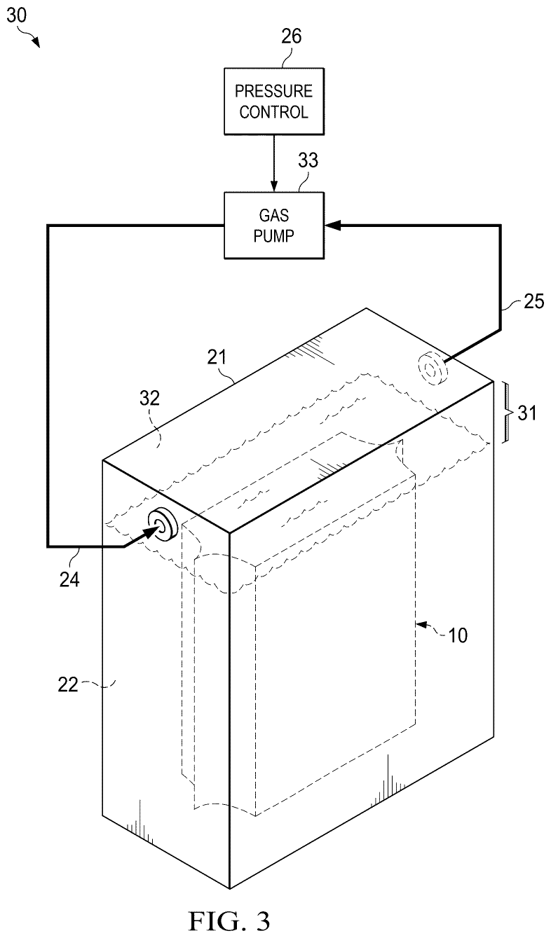

FIG. 3 illustrates an alternative embodiment to system 20, a pouch battery system 30 in which enclosure 21 is not completely filled with coolant 22. A headspace 31 above the liquid level of coolant 22 contains a gas 32. Gas may be vapors of a PCM coolant, air, or an inert gas. Gas 32 is used to control pressure within enclosure 21. Pump 33 may be used for this purpose and may be any one of various devices operable to increase the gas pressure within enclosure 21.

An advantage of the embodiment of FIG. 3 is that the compressibility of gas 32 provides damping, which may be useful during battery abuse. A further advantage is that the liquid level of coolant 22 may be adjusted independently of the pressure within enclosure 21.

Using either system 20 or system 30, controller 26 may receive various types of input for dynamic adjustment of the pressure within enclosure 21. Pressure may be adjusted as a function of the battery cell conditions (voltage, state-of-charge, age, state-of-health, temperature), and/or operating conditions (current) and/or cell ageing profile (known relationship between pressure and ageing). Controller 26 may receive measured and/or modeled battery data from a battery control unit (not shown) for this purpose.

Pressure within enclosure 21 may be adjusted during cycling under normal operating conditions to counteract the effects of battery ageing and/or provide optimal cell ageing. Additionally, using hydrostatic pressure to ensure a uniform compression pressure will itself delay cell ageing by avoiding cell damage due to non-uniform support. Controller 26 may store a cell aging profile, and adjust hydrostatic pressure in response to the cell's age. Additionally, dynamic adjustment of pressure during cell failure can ensure the desired failure pathway. This could include preemptive pressure release in a safe and controlled manner.

1. A pouch battery system, comprising one or more pouch batteries;
a fixed volume enclosure for containing the one or more pouch batteries;
wherein the enclosure is sealed, other than an inlet and outlet, such that it may also contain a coolant surrounding the one or more pouch batteries;
a pump operable to pump the coolant into and out of the enclosure via the input and outlet respectively, thereby varying the pressure exerted by the coolant upon the exterior of the pouch batteries; and
a controller operable to receive battery data representing at least one battery cell condition (voltage, state-of-charge, age, state-of-health, or temperature) and to control the pump in response to the battery data.

2. The pouch battery system of claim 1 wherein the pump is located within the enclosure.

3. The pouch battery system of claim 1 wherein the pump is located external to the enclosure.

4. A method of cooling pouch batteries, comprising:
placing the pouch batteries within a fixed volume enclosure;
wherein the enclosure is sealed, other than an inlet and outlet, such that it may also contain a coolant surrounding the one or more pouch batteries;
pumping the coolant into and out of the enclosure via the input and outlet respectively, thereby varying the pressure exerted by the coolant upon the exterior of the pouch batteries; and
wherein the pumping is in response to battery data representing at least one battery cell condition (voltage, state-of-charge, age, state-of-health, or temperature).

5. A pouch battery system, comprising
one or more pouch batteries;
a fixed volume enclosure for containing the one or more pouch batteries;
wherein the enclosure is sealed, other than an inlet and outlet, such that it may also contain a coolant surrounding the one or more pouch batteries and a gas in a space above the coolant and above the one or more pouch batteries;
a pump operable to pump the gas into and out of the enclosure, via the inlet and outlet, and to thereby vary the pressure exerted by the coolant upon the exterior of the pouch batteries; and
a controller operable to receive battery data representing at least one battery cell condition (voltage, state-of-charge, age, state-of-health, or temperature) and to control the pump in response to the battery data.
